(19) United States
(12) Patent Application Publication
(10) Pub. No.: US 2004/0160412 A1
(43) Pub. Date: Aug. 19, 2004

(54) Information processing apparatus

(75) Inventors: Naohiko Otake, Chiba (JP); Noriaki Nakagawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/762,480

(22) Filed: Jan. 23, 2004

(30) Foreign Application Priority Data
Feb. 13, 2003 (JP) 2003-035342

(51) Int. Cl. G09G 5/00

(52) U.S. Cl. 345/156

(57) ABSTRACT

An information processing apparatus includes a display, a common button, and one or more cursor keys. The common button functions as both an activation button for activating a predetermined program and a determination button for determining an item selected from options appearing on the display while the predetermined program is activated. The cursor keys are used for selecting the item and are arranged adjacent to the common keys.

### BACKGROUND OF THE INVENTION

1. Field of the Invention

The present invention relates to information processing apparatuses and, more specifically, to a technical field for enhancing the usability of operation of an information processing apparatus.

2. Description of the Related Art

In information processing apparatuses having displays and keyboards including a plurality of predetermined operating keys, personal computers or personal digital assistants (PDAs) are known. Some of them are equipped with pointing devices that function to move an on-screen pointer in a desired direction, or various buttons functioning as, for example, an activation button for activating a predetermined program.

Some conventional information processing apparatuses have buttons, so-called hot keys, which, for example, activate predetermined programs by a single operation of each of the buttons, as disclosed in Japanese Unexamined Patent Application Publication No. 2000-242395.

In the conventional information processing apparatuses as mentioned above, activating the predetermined program is performed by a single operation to the hot key. However, for doing other operations in the activated program, such as executing a selected item in the activated program, using another operating key is required. This often results in inconvenient operations.

In particular, when the required operating key is positioned apart from the hot key, users must move their hands between the hot key and the required operating key on an as-needed basis, leading to poor operability.

### SUMMARY OF THE INVENTION

Accordingly, it is an object of the present invention to provide an information processing apparatus that overcomes the above described problem and enhances the usability thereof.

In order to attain the object, according to an aspect, the present invention provides an information processing apparatus including a display, a common button, and at least one cursor key arranged adjacent to the common key. The common key functions as both an activation button for activating a predetermined program and a determination button for determining an item selected from options appearing on the display while the predetermined program is activated. The at least one cursor key is used for selecting the item.

Accordingly, different operations in an auxiliary input program can be performed without the user's hands being moved, thus enhancing the operability.

In particular, when the information processing apparatus is used as a portable apparatus, the user can operate the common button and the at least one cursor key while grasping the main unit 3 with both hands, thus enhancing the usability.

According to an aspect of the present invention, the information processing apparatus may further include a pointing device for moving a pointer appearing on the display in a desired direction. The pointing device may be arranged adjacent to the common button. Therefore, the operability and the usability are further enhanced.

In the information processing apparatus according to an aspect of the present invention, the at least one cursor key may comprise a plurality of cursor keys arranged around the perimeter of the pointing device and the common key may be arranged outside the perimeter of the plurality of cursor keys. This allows space to be used effectively and the information processing apparatus to be miniaturized.

### BRIEF DESCRIPTION OF THE DRAWINGS

FIG. 1 is a perspective view of an information processing apparatus according to an embodiment of the present invention when a display unit is opened;

FIG. 2 is a perspective view of the information processing apparatus when the display unit is closed;

FIG. 3 is a rear elevation view of the information processing apparatus when the display unit is closed;

FIG. 4 is a plan view of a main unit of the information processing apparatus;

FIG. 5 is a perspective view of the information processing apparatus when used as a portable apparatus;

FIG. 6 is a perspective view of another application of the information processing apparatus;

FIG. 7 shows an entry screen upon activating an auxiliary input program in a procedure of auxiliary input operations;

FIG. 8 shows a character input screen upon activating a program for inputting text in the procedure of auxiliary input operations;

FIG. 9 shows the entry screen that displays a character input by operation of an auxiliary input key and a list of candidates relating to the character in the procedure of auxiliary input operations, after the processing shown in FIG. 8;

FIG. 10 shows the entry screen that displays a state in which the desired item is selected from the list of candidates in the procedure of auxiliary input operations, after the processing shown in FIG. 9;

FIG. 11 shows the character input screen that displays a state in which the selected item is input in the procedure of auxiliary input operations, after the processing shown in FIG. 10;

FIG. 12 shows the entry screen that displays a character input by operation of an auxiliary input key and a list of candidates relating to the character in the procedure of auxiliary input operations, after the processing shown in FIG. 11;

FIG. 13 shows the character input screen that displays a state in which the selected item is input in the procedure of auxiliary input operations, after the processing shown in FIG. 12;

FIG. 14 shows the entry screen that displays a character input by operation of an auxiliary input key and a list of candidates relating to the character in the procedure of auxiliary input operations, after the processing shown in FIG. 13;

FIG. 15 shows the character input screen that displays a state in which the selected item is input in the procedure of auxiliary input operations, after the processing shown in FIG. 14.

### DESCRIPTION OF THE PREFERRED EMBODIMENTS

Embodiments of the present invention will now be described below with reference to the drawings. These embodiments relate to a portable information processing apparatus (personal computer) according to the present invention.

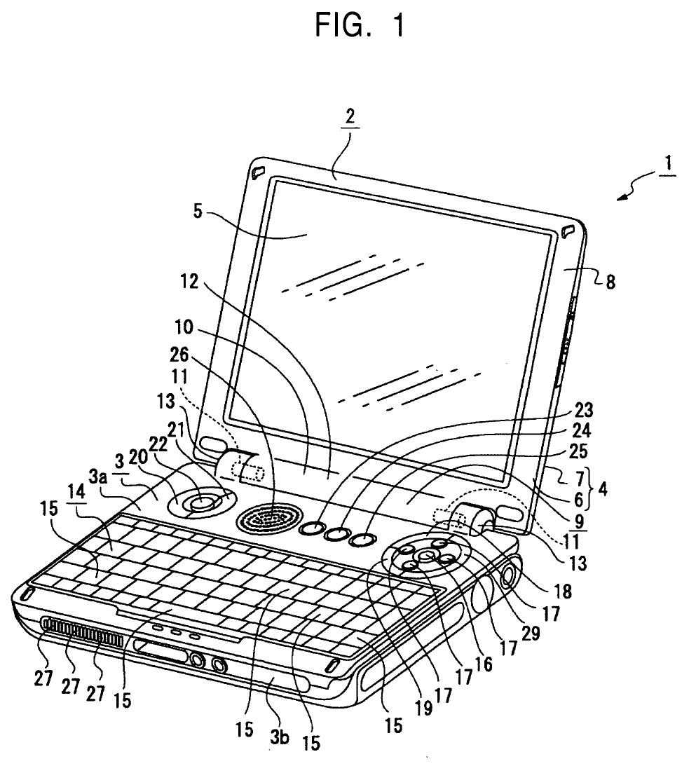

An information processing apparatus 1 has a display unit 2 and a main unit 3, as shown in FIGS. 1 to 3.

The display unit 2 has a display housing 4 and a display 5 arranged in the display housing 4.

In the display housing 4, a front panel 6 and a rear panel 7 are combined. The front panel 6 is a frame having an approximate rectangular outline. The rear panel 7 is a shallow box having an approximate rectangular outline and having an opening at the side facing the front panel 6. The outer region of the display housing 4 forms a frame portion 8.

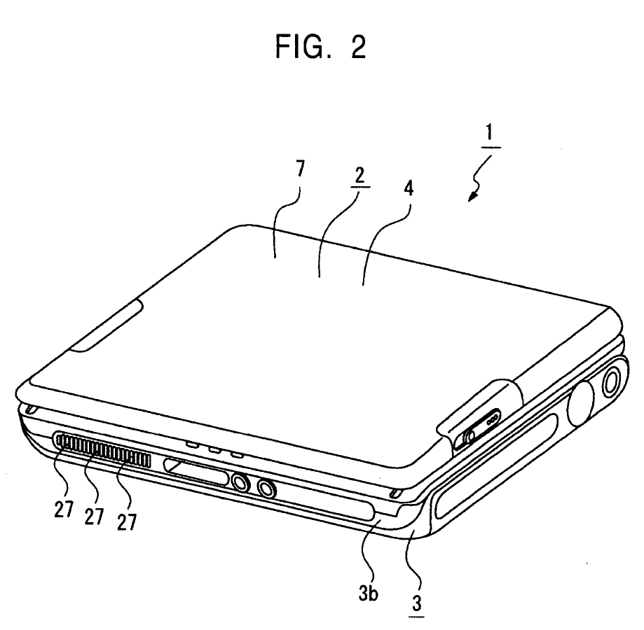

The display unit 2 is supported at the rear part of the main unit 3 with a hinge 9 extending transversely so as to be pivotable. The display unit 2 can pivot to a closed position of the main unit 3 for closing a keyboard, which is described later, when the information processing apparatus is not used, as shown in FIG. 2.

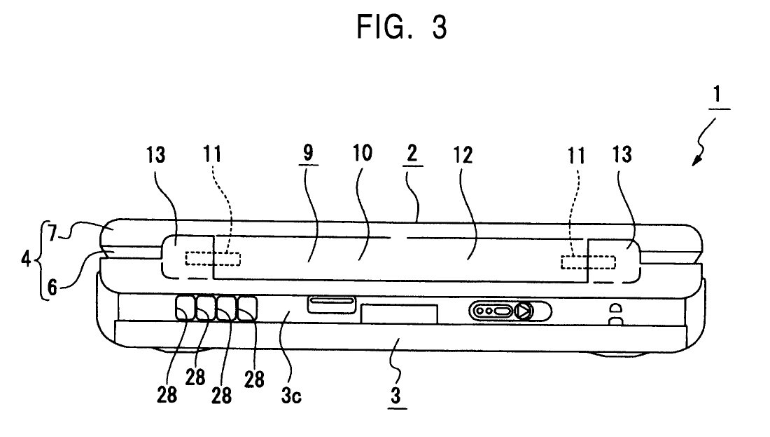

As shown in FIGS. 1 and 3, the hinge 9 is composed of a hinge barrel 10 and hinge pins 11 arranged inside the hinge barrel 10. The hinge barrel 10 is composed of a display hinge barrel 12 and main unit hinge barrels 13.

The display hinge barrel 12 is integrally attached to the display housing 4, projecting therefrom.

The main unit hinge barrels 13 are integrally attached to the external housing of the main unit 3, projecting therefrom.

As shown in FIGS. 1 and 3, the hinge pins 11 are arranged between the opposite ends of the display hinge barrel 12 and the main unit hinge barrels 13, connecting the display hinge barrel 12 and the main unit hinge barrels 13.

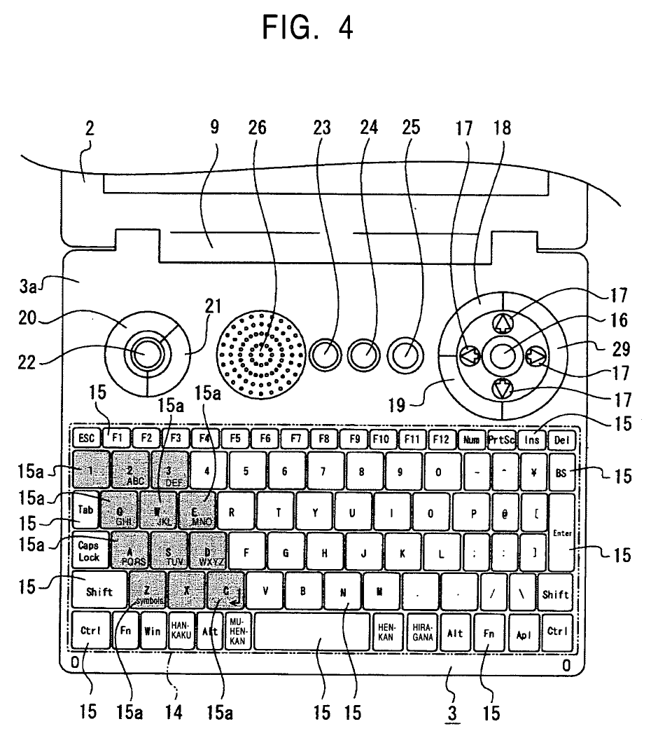

As shown in FIGS. 1 and 4, a keyboard 14 having longer sideways is arranged on a top face 3a of the main unit 3 away from the rear part of the main unit 3. The keyboard 14 has a plurality of predetermined operating keys 15. Processing means, such as a central processing unit (CPU), is arranged inside the main unit 3 and performs processing on signals input by operation of the operating keys 15 of the keyboard 14.

The operating keys 15 are composed of various kinds of keys, as shown in FIG. 4.

At the backmost row of the keyboard, i.e., at the first row, an escape (Esc) key, which is typically used for moving back to the previous stage, function keys F1 to F12, which are used for carrying out predetermined functions, and other keys are arranged.

At the second row, which is placed at the front of the backmost row, to the fifth row, input keys used for inputting predetermined alphanumerics are arranged. An enter key for confirming the entry is arranged across the third and fourth rows.

At the most frontward row, i.e., at the sixth row, control (Ctrl) keys and alternate (Alt) keys used for performing special functions in combination with other operating keys 15, a Windows™ key used for displaying the start menu of Windows software, a spacebar used for inputting a space character, and the like are arranged. The keyboard 14 has no cursor keys used for moving a cursor appearing on the display 5 vertically or horizontally.

Several keys of the operating keys 15 arranged at the left part also serve as auxiliary input keys 15a, which are shown as shaded keys in FIG. 4, used for inputting characters when an auxiliary input program, which is described later, is activated. When the auxiliary input program is activated, the character “A”, for example, is input by pressing an “ABC” auxiliary input key 15a, which is also labeled “2”, once; the character “b” is input by pressing the “ABC” auxiliary input key 15a five times.

On the rear part of the top face 3a of the main unit 3, a pointing device 16 may be arranged at its right end. Applying force to the pointing device 16 in a desired direction with a finger allows a pointer appearing on the display 5 to move in a corresponding direction.

At adjacent areas around the pointing device 16, four cursor keys 17 may be arranged. The cursor keys 17 are circumferentially spaced at regular intervals. Operating the cursor keys 17 allows the cursor appearing on the display 5 to move in a predetermined direction, i.e., vertically or horizontally.

At adjacent areas around the cursor keys 17, a switching button 18 and a common button 19 used for the auxiliary input are arranged. The switching button 18 and the common button 19 are arc-shaped. The switching button 18 is used for switching the orientation and the resolution of the display screen. The common button 19 functions, for example, to activate a program (hereinafter referred to as an “auxiliary input program”) for inputting characters by simple operations. The common button 19 functions as an activation button for activating a program and as a determination button for determining an item selected from options appearing on the display 5 in the program.

In the information processing apparatus 1, operating the switching button 18 allows a screen appearing on the display 5 to be rotated 90° and to be resized.

On the rear part of the top face 3a of the main unit 3, a left button 20, a right button 21, and a center button 22, each of which corresponds to each button of a mouse, are arranged at its left end. The left button 20 and the right button 21 are arc-shaped and surround the center button 22. The left button 20 and the right button 21 serve as a first function button and a second function button, respectively, for controlling an object selected with the pointer appearing on the display 5. The center button 22 serves as a third function button capable of scrolling a screen appearing on the display 5.

In the information processing apparatus 1, the left button 20 is larger than the right button 21. This is made with a view to enhance the operability in that, in general, the left button 20 is used with more frequency than the right button 21.

At the left of the switching button 18 and the common button 19 on the rear part of the top face 3a of the main unit 3, a power button 23, a standby button 24, and a brightness-control button 25 are arranged separately from the left to the right. The power button 23 is used for turning the power on. The standby button 24 is used for switching between a power-saving operating mode and a normal operating mode. The brightness-control button 25 is used for controlling illumination of a backlight of the display 5.

At the left of the power button 23 on the rear part of the top face 3a of the main unit 3, a speaker 26 is arranged.

At the left on a front edge 3b, air intakes 27 are laterally arranged, as shown in FIGS. 1 and 2. At the right on a rear edge 3c, air outlets 28 are laterally arranged, as shown in FIG. 3.

When the information processing apparatus 1 is in use, outside air enters the inside of the main unit 3 from the air intakes 27, thereby cooling the inside of the main unit 3. Air used in cooling then flows out through the air outlets 28.

When the information processing apparatus 1 is in use, the display unit 2 is opened at any angle from the main unit 3, as shown in FIGS. 1, 5, and 6. Therefore, the information processing apparatus 1 can be used as a stationary or portable apparatus.

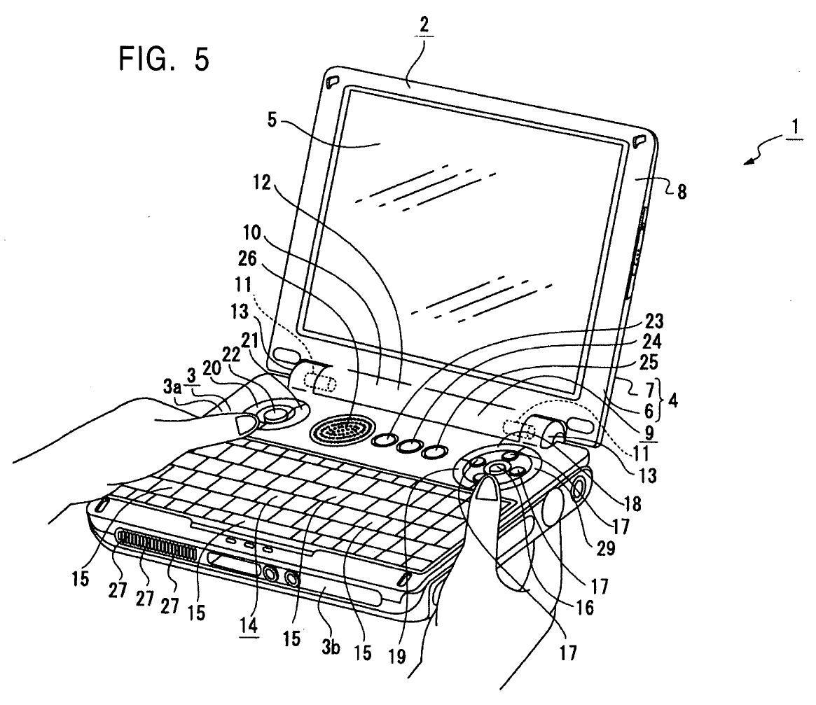

When using the information processing apparatus 1 as a portable apparatus, the user may operate it by grasping right and left sides of the main unit 3 with both hands, as shown in FIG. 5.

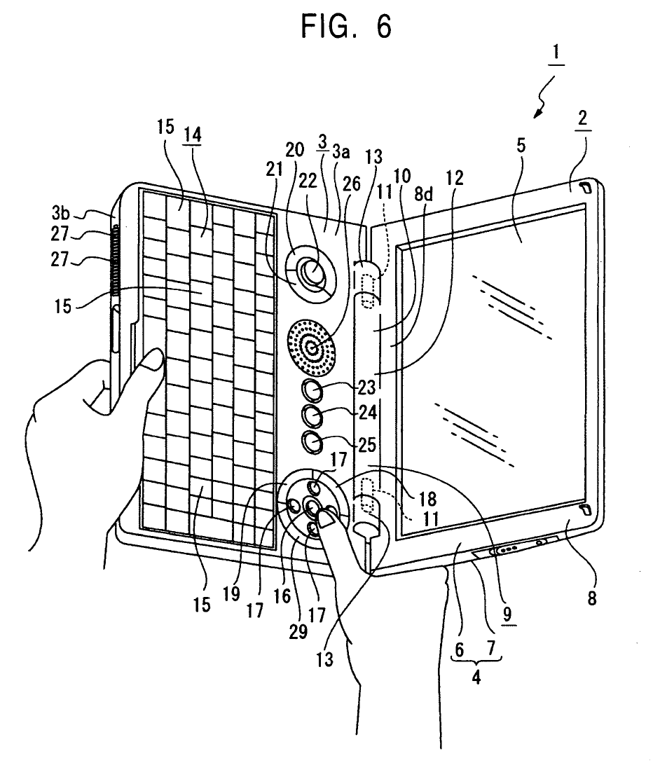

In the information processing apparatus 1, operating the switching button 18 can cause the orientation of the display screen to be rotated 90°, as described above. Therefore, when used as a portable apparatus, the information processing apparatus 1 can be operated in landscape orientation in which the main unit 3 is on the left side and the display unit 2 is on the right, as shown in FIG. 6.

As described above, the air outlets 28 are provided at the rear edge 3c of the main unit 3 so that air does not flow directly toward the user's hands, thus ensuring enhanced operability. Moreover, the air intakes 27 and the air outlets 28 are provided at the front edge 3b and the rear edge 3c, respectively, so that the user's hands do not obstruct the air intakes 27 and the air outlets 28 when the information processing apparatus 1 is used as a portable apparatus. The apparatus is thus adequately cooled. Additionally, since the air outlets 28 are not provided at the front edge 3b of the main unit 3, air does not flow directly toward the user, thus ensuring further enhanced operability.

Main functions of the buttons mentioned above will now be described below.

A finger applies force on the pointing device 16 in a desired direction so that the pointer appearing on the display 5 can move in a corresponding direction, as described above. In this case, the movement speed of the pointer can be controlled by controlling the force applied on the pointing device 16. Moreover, pressing (clicking) the left button 20 once can, for example, select a program or a menu pointed to with the pointer. Pressing (clicking) the left button 20 twice in rapid succession can, for example, activate (execute) a program or a menu pointed to with the pointer.

Operating the cursor keys 17 can move the cursor appearing on the display 5 vertically or horizontally, as described above.

Since the pointing device 16 and the cursor keys 17 have important functions in operation of the information processing apparatus 1 and are also used frequently, as described above, both are often operated in succession.

Accordingly, as in the information processing apparatus 1, the pointing device 16 and the cursor keys 17 are arranged closely so that the user can operate the pointing device 16 and the cursor keys 17 without moving the hands every time the user operates them, thus enhancing the operability.

In particular, when the information processing apparatus 1 is used as a portable apparatus, as shown in FIGS. 5 and 6, the user can operate the common button 19 and the cursor keys 17 while grasping the main unit 3 with both hands, thus enhancing the usability.

The cursor keys 17 are arranged at a different area from the keyboard 14 so that an area for arranging the keyboard 14 becomes larger, thus allowing increased sizes of the operating keys 15. The operability of the operating keys 15 is therefore improved.

Furthermore, the cursor keys 17 may be arranged around the perimeter of the pointing device 16 so that the positions where the cursor keys 17 are arranged can individually correspond to directions of movement of the cursor. Specifically, two keys of the cursor keys 17 for moving the cursor upward and downward may be arranged at front and rear positions relative to the pointing device 16, and the other two keys of the cursor keys 17 for moving the cursor leftward and rightward may be arranged at left and right positions relative to the pointing device 16.

The arrangement in which the positions of the cursor keys 17 individually correspond to the directions of cursor movement reduces misoperation relating to the cursor and improves the operability.

In the information processing apparatus 1, the pointing device 16 and the cursor keys 17 are arranged at the right end of the rear part in the top surface 3a of the main unit 3 so that the user can operate the pointing device 16 and the cursor keys 17 with the right hand while grasping the main unit 3 with the right hand when using the information processing apparatus 1 as a portable apparatus. This increases the usability of the information processing apparatus 1 used as a portable apparatus.

In the information processing apparatus 1, the switching button 18 and the common button 19 may be arranged outside the perimeter of the cursor keys 17. Additionally, a confirmation key (enter key) 29 may be arranged outside the perimeter of the cursor keys 17, as shown in FIGS. 1, 4, 5, and 6.

The confirmation key 29 is frequently used when, for example, confirming or executing an item selected with the pointing device 16 or the cursor keys 17. Therefore, arranging the confirmation key 29 outside the perimeter of the cursor keys 17 further enhances the operability and the usability.

Operating the common button 19 used for the auxiliary input can activate the auxiliary input program. The auxiliary input program has a predictive input function for predicting data to be input (hereinafter referred to as candidates) relating to an input character and displaying a list of the candidates on the display 5.

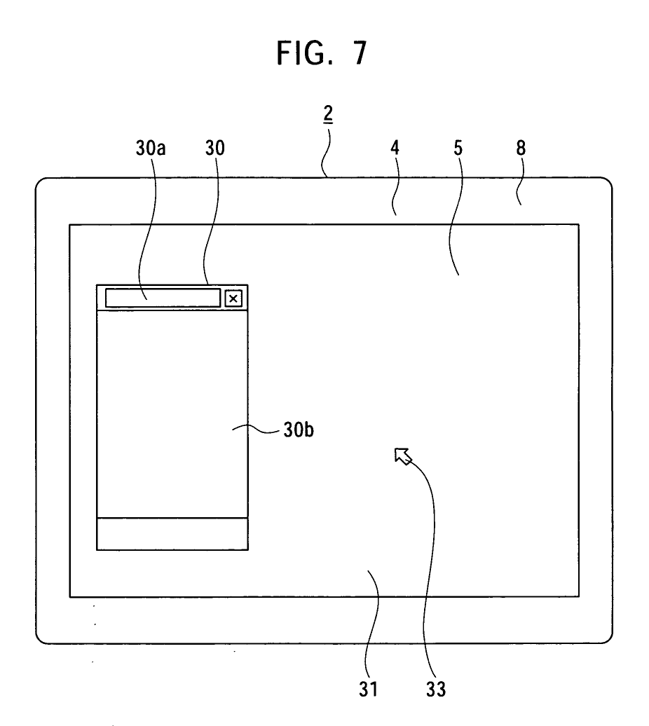

An auxiliary input process using the auxiliary input program will now be described below with reference to FIGS. 7 to 15.

Upon pressing the common button 19, the auxiliary input program is activated and an entry screen 30 appears on the display 5, as shown in FIG. 7. The entry screen 30 has a character displaying section 30a for displaying a typed character or typed characters and a list displaying section 30b for displaying a list of candidates relating to the typed character(s).

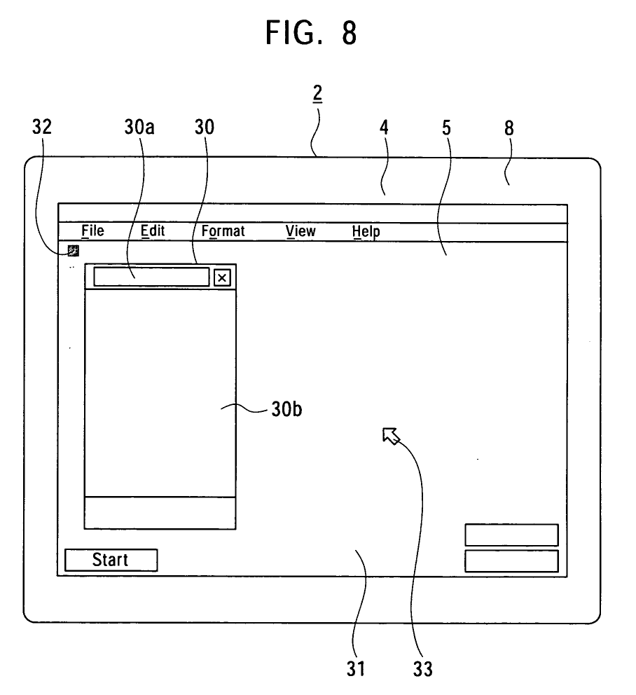

A desired program, such as a word processor, is then activated and a cursor 32 is moved to a desired input location on a character input screen 31 of the activated program, as shown in FIG. 8. The cursor 32 is moved by the cursor keys 17 being operated or by a pointer 33 being moved with the pointing device 16.

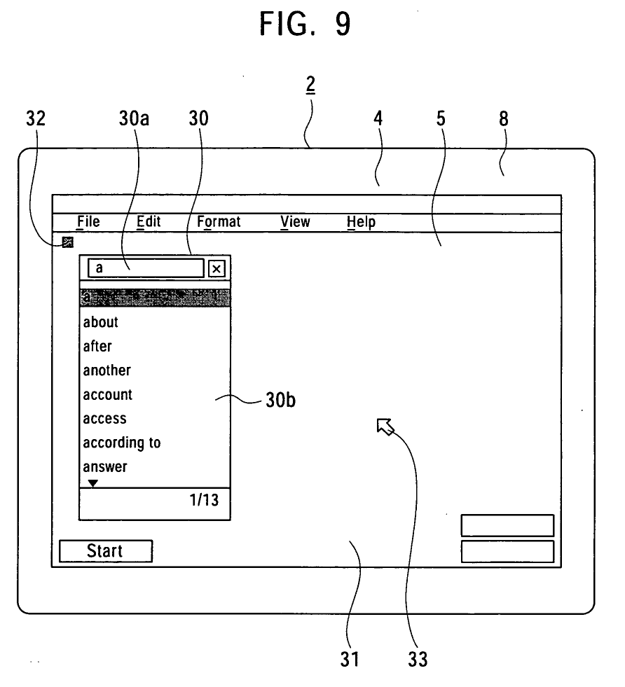

For example, to input “agenda for today”, firstly the “ABC” auxiliary input key 15a is pressed four times. Then, the character “a” appears on the character displaying section 30a and a list of candidates relating to “a” appears on the list displaying section 30b, as shown in FIG. 9.

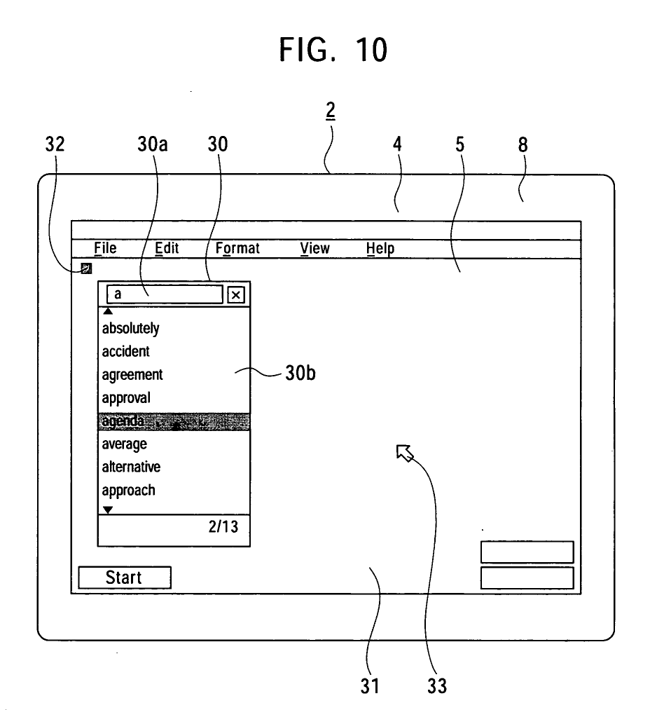

Then, “agenda” or “agenda for” is retrieved from the list of candidates appearing on the list displaying section 30b. This search is performed by one key (marked with the down arrow) of the cursor keys 17 being pressed one or more times until the “agenda” or “agenda for” appears on the list displaying section 30b, as shown in FIG. 10.

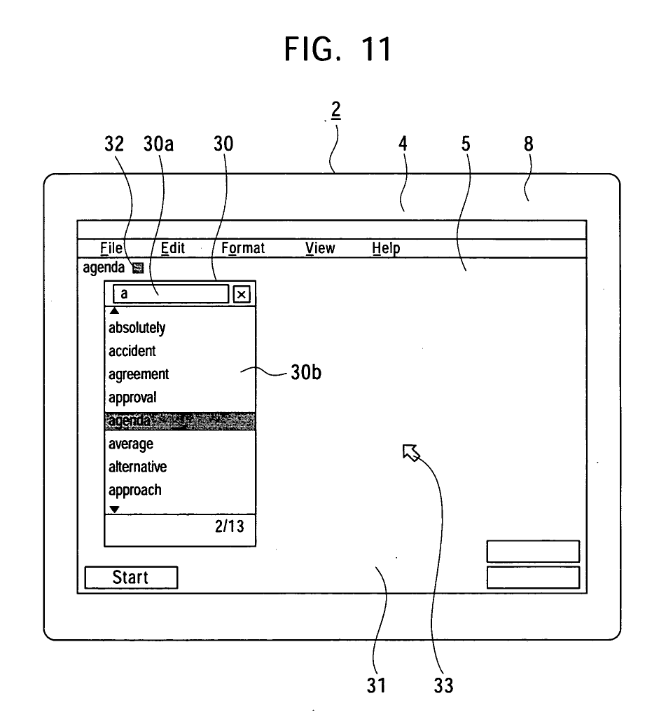

After the “agenda” appears on the list displaying section 30b, the “agenda” is selected and then the common button 19 is pressed to confirm the selection. When the selection is confirmed, “agenda” is input at a location of the cursor 32 on the character input screen 31 of the activated software, as shown in FIG. 11.

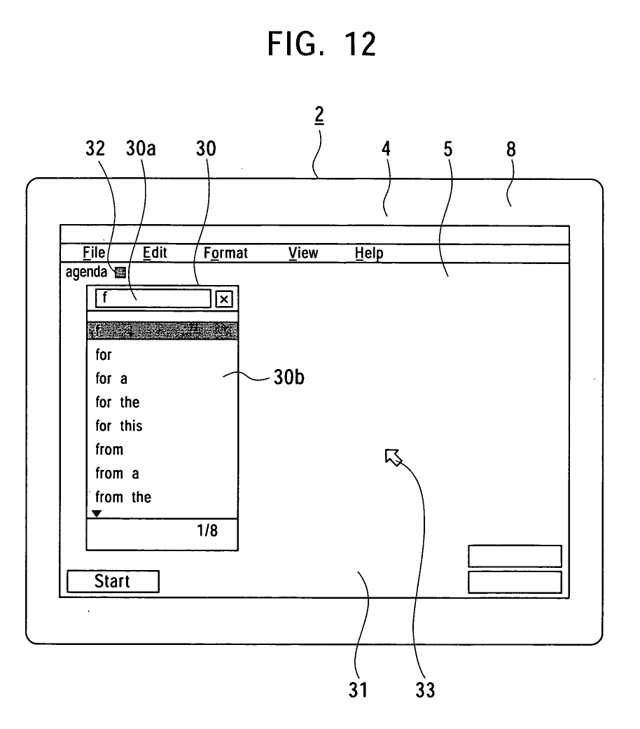

Secondly, a “DEF” auxiliary input key 15a is pressed six times. Then, the character “f” appears on the character displaying section 30a and a list of candidates relating to “f” appears on the list displaying section 30b, as show in FIG. 12.

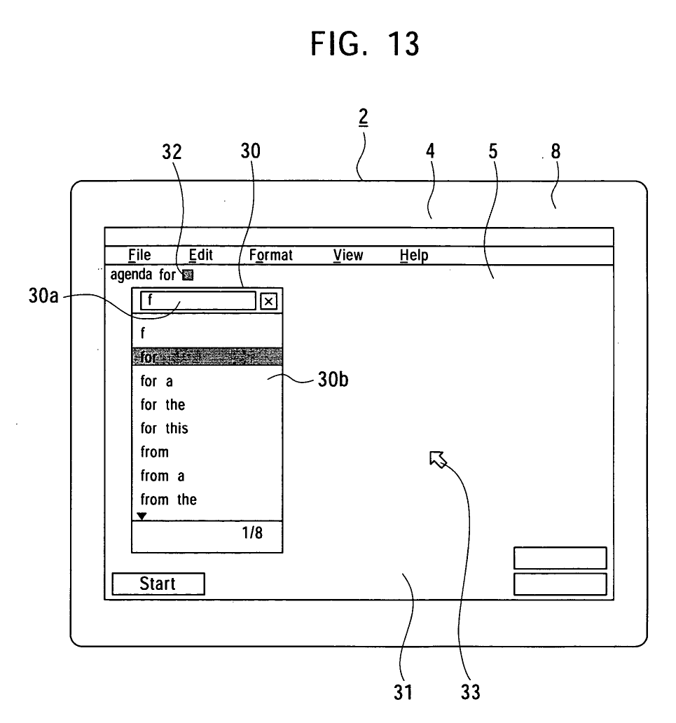

Then, “for” is retrieved and selected from the list of candidates appearing on the list displaying section 30b. The selection is then confirmed by the common button 19 being pressed. Then, “for” is input at a location of the cursor 32 on the character input screen 31 and “agenda for” appears on the character input screen 31, as shown in FIG. 13.

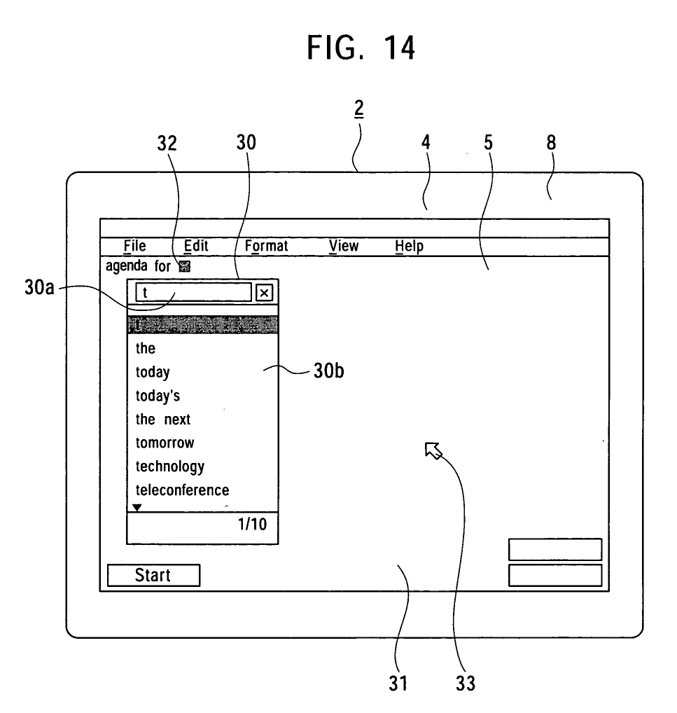

Thirdly, a “TUV” auxiliary input key 15a is pressed four times. Then, the character “t” appears on the character displaying section 30a and a list of candidates relating to “t” appears on the list displaying section 30b, as shown in FIG. 14.

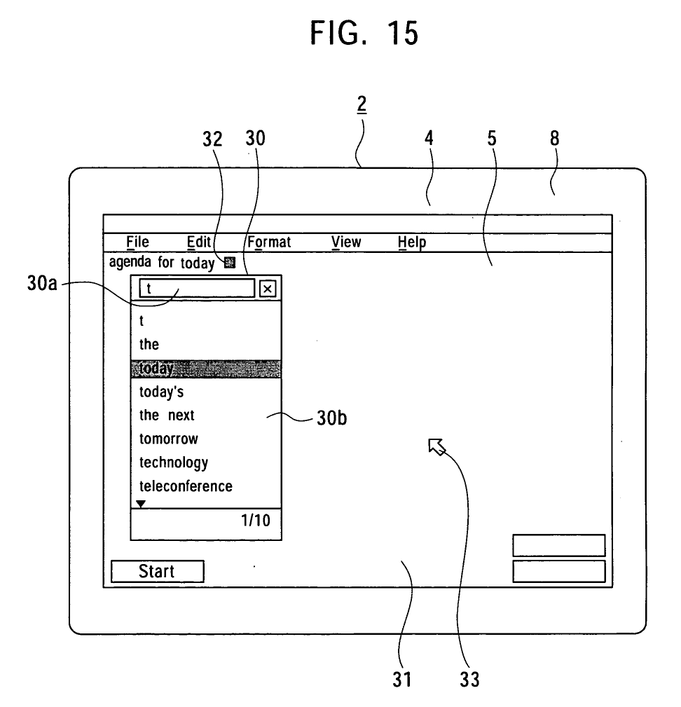

Then, “today” is retrieved from the list of candidates appearing on the list displaying section 30b. This search is performed by the one key (marked with the down arrow) of the cursor key 17 being pressed one or more times until the “today” appears on the list displaying section 30b, as shown in FIG. 15.

After the “today” appears on the list displaying section 30b, the “today” is selected and then the common button 19 is pressed to confirm the selection. When the selection is confirmed, “today” is input at a location of the cursor 32 on the character input screen 31 and “agenda for today” then appears on the character input screen 31, as shown in FIG. 15.

In this way, the operation of the auxiliary input ends when the “agenda for today” is input on the character input screen 31.

As described above, the information processing apparatus 1 has the common button 19 functioning to activate the auxiliary input program and to confirm an item selected with the cursor keys 17. Therefore, different operations in the auxiliary input program can be performed by a single button, thus decreasing the number of buttons without losing functionality and also enhancing the operability.

Moreover, the cursor keys 17 and the common button 19 are arranged closely so that different operations in the auxiliary input program can be performed without the user's hand being moved, thus enhancing the operability.

In particular, when the information processing apparatus 1 is used as a portable apparatus, as shown in FIGS. 5 and 6, the user can operate the common button 19 and the cursor keys 17 while grasping the main unit 3 with both hands, thus enhancing the usability.

Further, the pointing device 16 and the common button 19, which are operated in the auxiliary input program, are arranged closely so that the operability and the usability are further enhanced.

Additionally, the plurality of the cursor keys 17 may be arranged around the perimeter of the pointing device 16 and the common button 19 may be arranged outside the perimeter of the cursor keys 17 in the information processing apparatus 1, thus allowing space on the main unit 3 to be used effectively and the information processing apparatus 1 to be miniaturized.

Pressing the left button 20 once can select, for example, a program or a menu that is pointed to with the pointer. Pressing the left button 20 twice in rapid succession can activate (execute) a program or menu that is pointed to with the pointer. These operations can be also performed by the pointing device 16 being pressed (clicked) once or twice in rapid succession, as described above.

Pressing the right button 21 can display a submenu (pop-up menu) including various items at a location of the cursor. Operating the pointing device 16 or the cursor keys 17 can select an item in the submenu. The selected item in the submenu can be executed with the left button 20, the pointing device 16, the enter key of the keyboard, or the confirmation key 29.

Furthermore, the pointer is placed over a desired item, such as an icon on the display 5, and the left button 20 is pressed and held, and force is then applied on the pointing device 16 in a desired direction so that the item over which the pointer is placed can be moved to any location on the display 5.

Additionally, the center button 22 is pressed and held, and force is then applied on the pointing device 16 in a predetermined direction so that the display screen is scrolled in the predetermined direction. For example, when the center button 22 is pressed and held, the forces with horizontal and vertical directions on the pointing device 16 cause horizontal scrolling and the vertical scrolling of the display screen, respectively.

In the information processing apparatus 1, the user can vertically operate the pointing device 16 immediately after horizontally operating the pointing device 16, without moving the fingers off the pointing device 16, while holding down the center button 22. Therefore, the user can perform horizontal scrolling of the display screen and successive vertical scrolling thereof. Similarly, the user can horizontally operate the pointing device 16 immediately after vertically operating the pointing device 16, without moving the fingers off the pointing device 16, while holding down the center button 22. Therefore, the user can perform vertical scrolling and successive horizontal scrolling.

The scrolling of the display screen described above is made by the pointing device 16 being operated after the center button 22 is pressed and held. Alternatively, the scrolling may be made by the fingers' applying force on the center button 22 in a desired direction without the pointing device 16 being operated.

In the information processing apparatus 1, the left button 20, the right button 21, and the center button 22 are arranged at the left end of the rear part of the top surface 3a of the main unit 3 so that the user can operate them with the left hand while grasping the main unit 3 with the left hand when the information processing apparatus 1 is used as a portable apparatus. This enhances the usability of the information processing apparatus 1 used as a portable apparatus.

In particular, since the left button 20, the right button 21, and the center button 22 are frequently used and also they are often used in succession, they are arranged closely so that different operations can be achieved without the hands being moved, thus enhancing the operability.

Moreover, the left button 20 and the right button 21 may be arranged around the perimeter of the center button 22 so that space on the main unit 3 is effectively used, thus allowing the information processing apparatus 1 to be miniaturized.

Further, the pointing device 16 and the cursor keys 17, which are frequently used, are arranged on the main unit 3 at the end opposite to where the left button 20, the right button 21, and the center button 22 are arranged so that the user can operate the left button 20, the right button 21, and the center button 22 with the left hand while grasping the main unit 3 with the left hand and can operate the pointing device 16 and the cursor keys 17 with the right hand while grasping the main unit 3 with the right hand. The usability is therefore enhanced.

The scrolling of the display screen described above is made by the center button 22 being operated. The center button 22 may further have the functions of the left button 20, the right button 21, and the like.

Operating the cursor keys 17 while holding down the center button 22 may move the cursor to the next or previous page on a page-to-page basis.

The pointing device 16, the cursor keys 17, the switching button 18, the common button 19, and the confirmation key 29 are arranged at the right end of the main unit 3 and the left button 20, the right button 21, and the center button 22 are arranged at the left end of the main unit 3, as described above. Alternatively, the left button 20, the right button 21, and the center button 22 may be arranged at the right end of the main unit 3 and the pointing device 16, the cursor keys 17, the switching button 18, the common button 19, and the confirmation key 29 may be arranged at the left end of the main unit 3.

It should be understood that the shapes or structures of the components described above according to the present invention are illustrative only and are not intended to limit the scope of the present invention.

What is claimed is:

1. An information processing apparatus comprising:
a display;
a common button functioning as both an activation button for activating a predetermined program and a determination button for determining an item selected from options appearing on the display while the predetermined program is activated; and
at least one cursor key for selecting the item, the cursor key being arranged adjacent to the common key.

2. The information processing apparatus according to claim 1, further comprising a pointing device for moving a pointer appearing on the display in a desired direction, the pointing device being arranged adjacent to the common button.

3. The information processing apparatus according to claim 2, wherein the at least one cursor key comprises a plurality of cursor keys arranged around the perimeter of the pointing device and the common key is arranged outside the perimeter of the plurality of cursor keys.
